(19) United States
(12) Patent Application Publication
(10) Pub. No.: US 2011/0317437 A1
(43) Pub. Date: Dec. 29, 2011

(54) LED ILLUMINATING DEVICE

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/040,300

(22) Filed: Mar. 4, 2011

(30) Foreign Application Priority Data
Jun. 28, 2010 (CN) 201010210836.6

(51) Int. Cl. F21V 29/00

(52) U.S. Cl. 362/373

(57) ABSTRACT

An LED illuminating device includes a base plate, a substrate mounted on the base plate, a connector, a hollow heat sink including two opposite open ends and at least one support portion formed at an inside lateral surface thereof, and a driving circuit. The base plate and the connector are respectively connected to the two opposite open ends of the heat sink. A top wall of the at least one support portion contacts and supports the base plate for transferring the heat generated by the LEDs from the base plate to the heat sink.

### BACKGROUND

1. Technical Field

The present disclosure relates to light emitting diode (LED) illuminating devices and, particularly, to an LED illuminating device with heat dissipation module.

2. Description of Related Art

Compared to traditional light sources, light emitting diodes (LEDs) have advantages, such as high luminous efficiency, low power consumption, and long service life. To dissipate heat from LED lamps, a type of heat sink, which is called “sunflower heat sink”, is used in LED lamps having a plurality of LEDs. The sunflower heat sink has a post-shaped conductive member and a plurality of fins extending outwardly and radially from a lateral surface of the conductive member. One problem with the LED illuminating device is its large size and heavy weight. In addition, dust tends to contaminate the spaces between the fins, which affect heat dissipation.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an assembled, isometric view of an LED illuminating device in accordance with an exemplary embodiment.

FIG. 2 is an isometric, exploded view of the LED illuminating device of FIG. 1.

FIG. 3 is a schematic, cross-sectional view of the LED illuminating device of FIG. 1.

FIG. 4 is a schematic view of a heat sink of the LED illuminating device of FIG. 1.

### DETAILED DESCRIPTION

Embodiments of the present disclosure are now described in detail, with reference to the accompanying drawings.

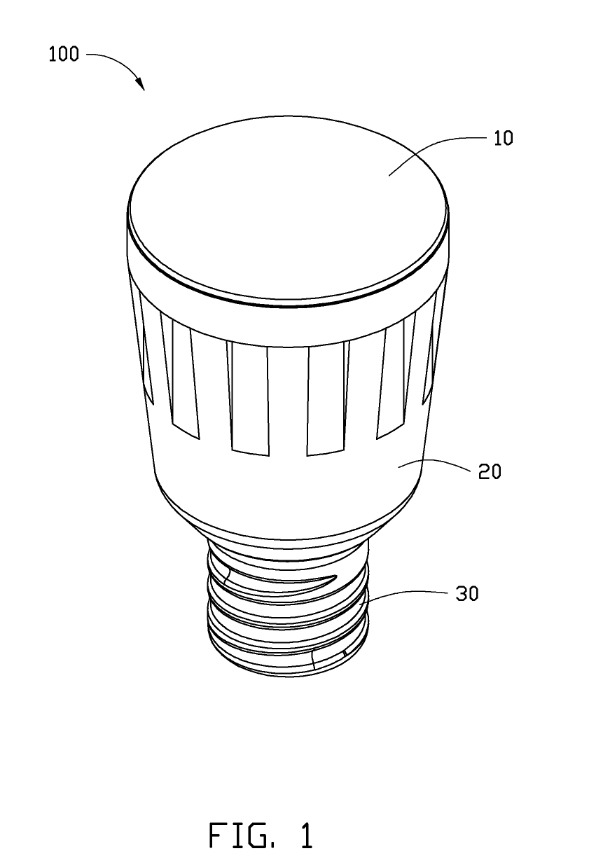

Referring to FIG. 1, an embodiment of an LED illuminating device 100 is illustrated. The LED illuminating device 100 includes a cover 10, a heat sink 20, a connector 30 and a driving circuit (not shown). The heat sink 20 is a hollow housing with two opposite open ends. The heat sink 20 can be made of metal with excellent heat conductivity, such as copper or aluminum. The cover 10 and the connector 30 are respectively attached to the two opposite open ends of the heat sink 20. The connector 30 is used to connect with a coupling connector to electrically connect the LED illuminating device 100 to a power source.

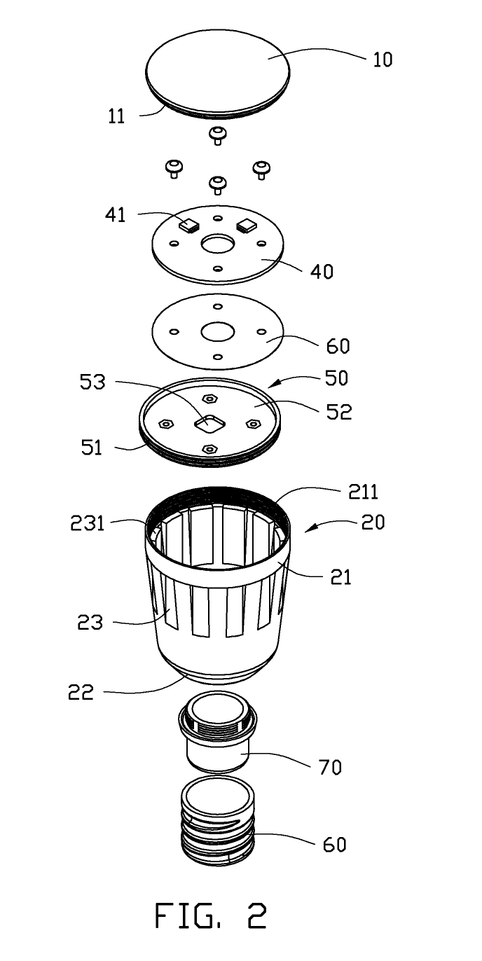

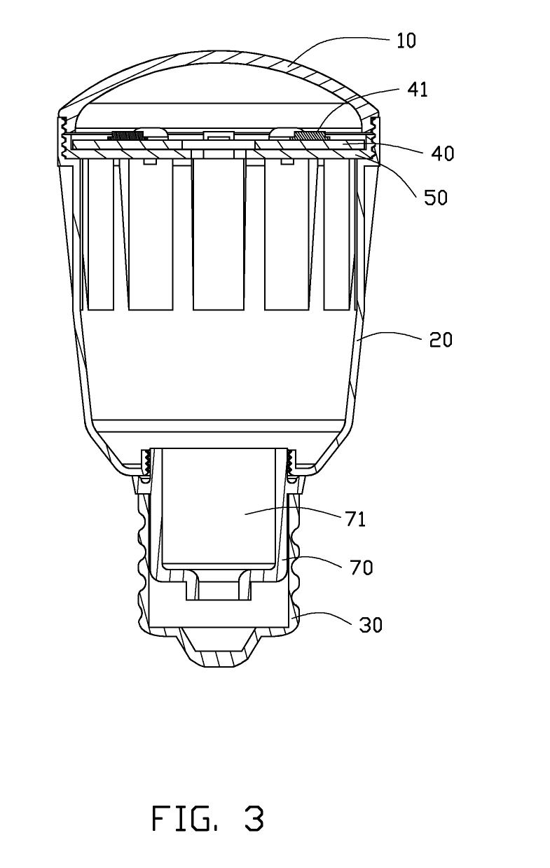

Referring to FIGS. 2 and 3, the LED illuminating device 100 further includes an LED substrate 40, a base plate 50, a heat-conductive medium 60, and an insulator 70. A number of LEDs 41 are arranged on the LED substrate 40. The driving circuit is contained in the heat sink 20, and electrically connected to the connector 30 and the LED substrate 40.

In this embodiment, the base plate 50 is made of metal with excellent heat conductivity, such as copper or aluminum, and is shaped like a flat disc. In another embodiment, the base plate 50 can be made of ceramic. A recess 52 is formed in the top surface of the base plate 50 for receiving the LED substrate 40 therein. The base plate 50 includes an external thread 51 formed on the sidewall of the base plate 50, and at least one through hole 53 allowing the cables connecting the LED substrate 40 and the driving circuit to pass through. The heat-conductive medium 60 is a graphite sheet arranged between the LED substrate 40 and the top surface of the base plate 50, for transferring the heat generated by the LEDs 41 from the LED substrate 40 to the base plate 50 homogeneously. In other embodiments, the heat-conductive medium 60 can be thermal conductive glue or heat-conductive ceramic. A heat-conductive material is set between the gap of the LED substrate 40 and the side wall of recess 52 to improve the heat-conductive efficiency of the LED illuminating device 100.

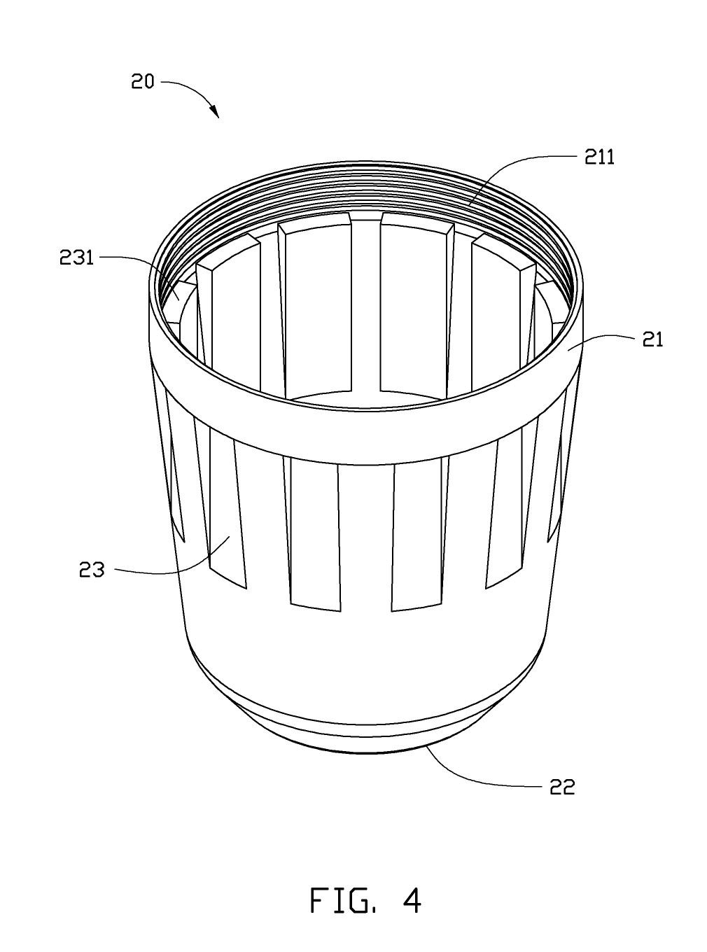

Referring to FIG. 4, the heat sink 20 includes a first end 21 and a second end 22. An internal thread 211 is formed in the inner wall of the first end 21. The base plate 50 is connected to the first end 21 by the engagement between the internal thread 211 and the external thread 51. The engagement increases the contact area between the internal thread 211 and the external thread 51, which promotes the heat exchange between the base plate 50 and the heat sink 20. In the embodiment, a heat-conductive material can be filled between the internal thread 211 and the external thread 51 to improve the thermal resistance therein. An external thread 11 is formed in the side wall of the cover 10. The cover 10 is connected to the first end 21 of the heat sink 20 by the engagement between the internal thread 211 and the external thread 11. An insulator 70 is arranged between the second end 22 of the heat sink 20 and the connector 30, and connects the heat sink 20 and the connector 30 together. The insulator 70 includes a through hole 71 allowing the wires connecting the connector 30 and the driving circuit to pass through.

At least one support portion 23 is formed on the heat sink 20. In the embodiment, the support portion 23 is sunken in the lateral surface of the heat sink 20. The inner top wall 231 of the support portion 23 supports the base plate 50. The contact of the base plate 50 and the inner top wall 231 creates a large heat-conductive area, which promotes heat exchange between the heat sink 20 and the base plate 50. In the embodiment, a heat-conductive material can be filled between the base plate 50 and the inner top wall 231, to improve the thermal resistance therein.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A light emitting diode (LED) illuminating device, comprising:
a base plate;
an LED substrate mounted on the base plate and comprising a plurality of LEDs;
a connector configured to connect with a coupling connector to electrically connect the LED illuminating device to a power source;
a hollow heat sink comprising two opposite open ends and at least one support portion formed at an inside lateral surface thereof; and
a driving circuit;
wherein the base plate and the connector are respectively connected to the two opposite open ends of the heat sink, a top wall of the at least one support portion contacts and supports the base plate for transferring the heat generated by the LEDs from the base plate to the heat sink.

2. The LED illuminating device according to claim 1, wherein an external thread is formed in the side wall of the base plate, and an internal thread is formed in the inner wall of the one end of the heat sink, the base plate is connected to the heat sink by the engagement between the internal thread and the external thread.

3. The LED illuminating device according to claim 1, wherein a recess is formed in the top surface of the base plate for receiving the LED substrate therein.

4. The LED illuminating device according to claim 3, wherein a heat-conductive material is set between the LED substrate and the side wall of recess.

5. The LED illuminating device according to claim 1, wherein the base plate is made of metal or ceramic.

6. The LED illuminating device according to claim 1, wherein a heat-conductive medium is arranged between the LED substrate and the top surface of the base plate for transferring the heat generated by the LEDs from the LED substrate to the base plate homogeneously.

7. The LED illuminating device according to claim 6, wherein the heat-conductive medium is a graphite sheet, thermal conductivity glue or heat-conductive ceramic.

8. The LED illuminating device according to claim 1, wherein the base plate further comprises at least one through hole allowing the cables connecting the LED substrate and the driving circuit to pass through.
